(19) United States
(12) Patent Application Publication
(10) Pub. No.: US 2006/0268666 A1
(43) Pub. Date: Nov. 30, 2006

(54) Electronic device with view-inhibitable display

(76) Inventor: Ronald S. Lizzi, Bethany, CT (US)

Correspondence Address: Arthur G. Schaier;Carmody & Torrance LLP, 50 Leavenworth Street, P.O. Box 1110, Waterbury, CT, 06721-1110, US

(21) Appl. No.: 11/141,972

(22) Filed: May 31, 2005

(51) Int. Cl. G04B 19/24; G04B 19/00; G04C 17/00

(52) U.S. Cl. 368/223; 368/28

(57) ABSTRACT

An electronic device comprising a view-inhibitable display, the electronic device comprising a dial having an actuation side and a display side, wherein the dial further comprises a display window; a display assembly, comprising a display for displaying information, positioned on the actuation side of the dial; a view-inhibiting assembly for inhibiting the view of the display through the display window in the dial; and inhibiting means, operatively coupled to the view-inhibiting assembly, for causing the view-inhibiting assembly to inhibit the view of the display through the display window. In a first embodiment, when the view-inhibiting assembly inhibits the view of the display through the display window in the dial, there is an absence of information visible in the display window. In an alternative embodiment, the view-inhibiting assembly comprises indicia different from the information being displayed by the display when the display is visible through the display window. In yet another embodiment, the view-inhibiting assembly comprises a ring, wherein the ring is divided into regions (i) having indicia thereon and (ii) that are transparent such that when the ring rotates so that the regions with indicia thereon are viewable within the display window, the display is not visible in the display window and when the ring rotates so that the transparent regions are viewable within the display window, the display is visible in the display window. In the preferred embodiment, the electronic device is a wristwatch.

### BACKGROUND OF THE INVENTION

The present invention relates generally to electronic devices, and timepieces such as wristwatches by way of example and not limitation, and in particular, to improved constructions and methodologies for among other things, improving the aesthetic display qualities of the electronic device.

There exists in the prior art a plethora of styles of timepieces and other types of wristworn devices. By way of example and not limitation, one well-known watch style is fondly known as the “combo” in that it includes both analog and digital timekeeping functionality. One exemplary such style is described and illustrated in U.S. Pat. No. 5,691,962, which can be seen to include both an analog display of information (i.e. using hands) and a digital display of information (e.g. using an LCD).

One of the perceived deficiencies of such (e.g. “combo” watch) styles is that to at least some consumers, the constant viewability of the digital display can diminish the aesthetic quality of the dial. Thus, it would be desirable to provide a construction and methodology that overcomes such perceived deficiencies. In particular, it would be desirable to be able to inhibit the viewing of any display provided below the dial, such as the aforementioned digital display, when desired. More specifically, it would be advantageous if a user could inhibit (e.g. “cover”) the underlying (e.g. digital) display when desired in order to change the aesthetics of the dial and, at least in the particular user's mind, provide “improvements” therein.

It is believed that the present invention overcomes the perceived deficiencies in the prior art noted above and further achieves the aforementioned and below mentioned objectives.

### SUMMARY AND OBJECTIVES OF THE INVENTION

Accordingly, it is an objective of the present invention to provide an electronic device with a changeable display capability, which can be perceived as improving the aesthetics of the display dial.

It is yet another object of the present invention to provide an improved electronic device construction that provides for increased versatility by providing a secondary display capability (e.g. day display) in the location of a first display that may be displaying different and/or unrelated information (e.g. time, date, alarm, temperature and/or compass headings).

Still other objects and advantages of the invention will in part be obvious and will in part be apparent from the specification.

The invention accordingly comprises the features of construction, combination of elements, arrangement of parts and sequence of steps which will be exemplified in the construction, illustration and description hereinafter set forth, and the scope of the invention will be indicated in the claims.

Generally speaking, in accordance with the present invention, an improved electronic device comprising a view-inhibitable display is provided. In the broadest embodiment, the electronic device comprises a dial having an actuation side and a display side, wherein the dial further comprises a display window; a display assembly, comprising a display for displaying information, positioned on the actuation side of the dial; a view-inhibiting assembly for inhibiting the view of the display through the display window in the dial; and inhibiting means, operatively coupled to the view-inhibiting assembly, for causing the view-inhibiting assembly to inhibit the view of the display through the display window. In a first embodiment, when the view-inhibiting assembly inhibits the view of the display through the display window in the dial, there is an absence of information visible in the display window. In an alternative embodiment, the view-inhibiting assembly comprises indicia different from the information being displayed by the display when the display is visible through the display window.

In yet another embodiment, the view-inhibiting assembly comprises a ring, wherein the ring is divided into regions (i) having indicia thereon and (ii) that are transparent such that when the ring rotates so that the regions with indicia thereon are viewable within the display window, the display is not visible in the display window and when the ring rotates so that the transparent regions are viewable within the display window, the display is visible in the display window. In this embodiment, the ring is preferably a day ring.

In the preferred embodiment, the electronic device is a wristwatch.

### BRIEF DESCRIPTION OF THE DRAWINGS

For a fuller understanding of the invention, reference is had to the following description taken in connection with the accompanying figures, in which:

FIG. 1 is a top plan view of an electronic device in the form of a timepiece, constructed in accordance with the present invention;

FIG. 2 is top plan view of the specific construction of the inner workings of an electronic device constructed in accordance with a first embodiment of the present invention;

FIG. 3 is a top plan view of an electronic device in the form of a timepiece, constructed in accordance with the first embodiment of the present invention;

FIG. 4 is close up view of a portion of the components illustrated in FIG. 2;

FIG. 5 is a top plan view of an electronic device in the form of a timepiece, constructed in accordance with a second embodiment of the present invention;

FIGS. 6 and 7 are top plan view of the specific construction of the inner workings of an electronic device constructed in accordance with the second embodiment of the present invention; and

FIG. 8 is a top plan view of a specific construction of the inner workings of an electronic device constructed in accordance with yet another embodiment of the present invention.

Also, while not all elements are labeled in each figure, all elements with the same reference number indicated similar or identical parts.

### DETAILED DESCRIPTION OF THE PREFERRED EMBODIMENTS

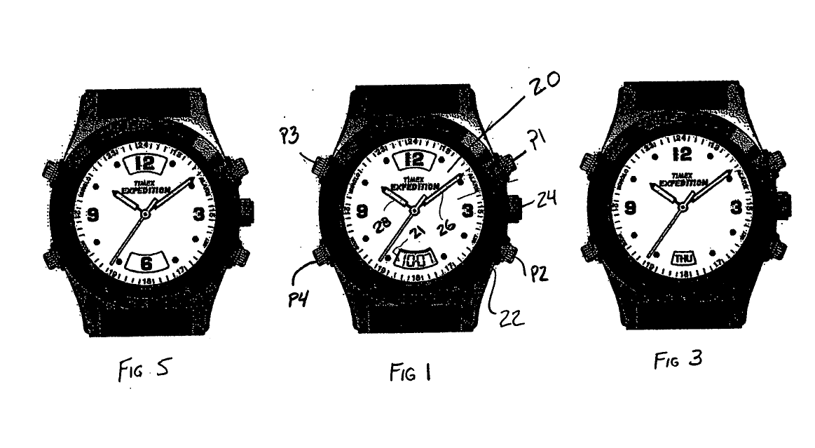

Reference shall first be made to FIGS. 1-2, which show an electronic device, generally indicated at 10, constructed in accordance with the present invention.

FIG. 1 illustrates electronic device 10 comprising a dial 20 (with a display window 21) on which a plurality of digits (e.g. “12”, “3” and “9”) and/or other demarcations may be printed, silkscreen, painted, or otherwise provided. A plurality of pushers, shown generically as P1, P2, P3, P4 are shown positioned around the outer periphery of a casing 22. A crown 24 is provided to set minute and hour hands 26, 28 in accordance with known methodologies and construction.

As generally illustrated in FIG. 1 and more clearly in FIG. 2, electronic device 10 further comprises a display assembly, generally indicated at 30, comprising a display 32 (in the preferable but not necessarily in the form of an LCD) for displaying information, positioned on the actuation side of dial 20. As would be known in the art, display 32 can display a wide array of information, including but not limited to, the date, temperature, alarm settings, the time and compass headings, just to name but a few examples.

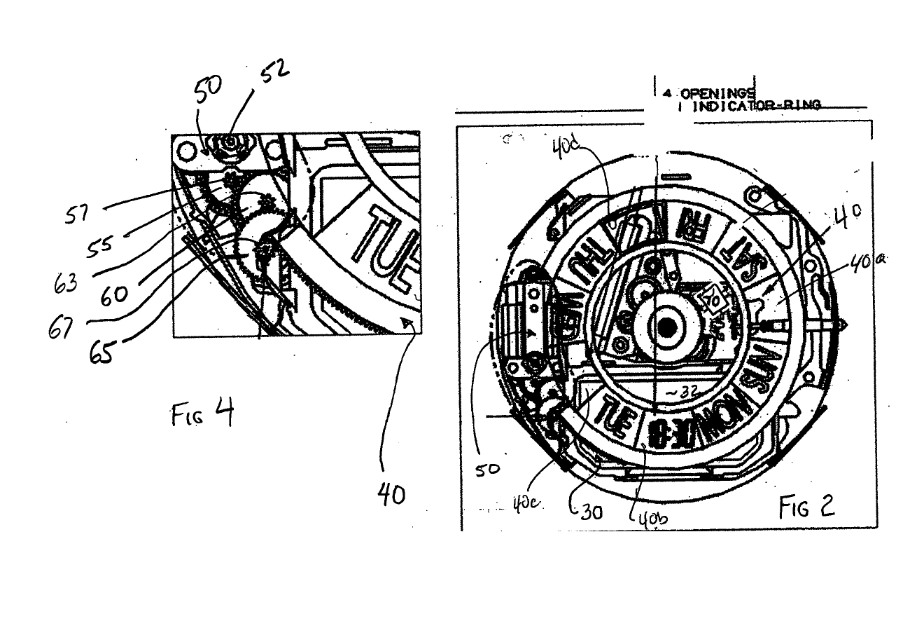

In order to appreciate the first embodiment of the present invention, reference is briefly made to FIG. 3, which illustrates electronic device 10 with display 32 being view-inhibited. Specifically, in this embodiment, inhibiting means are provided for causing a view-inhibiting assembly comprising a ring 40 to inhibit the view of display 32 through display window 21. As illustrated in FIG. 3, view-inhibiting assembly 40, in the first embodiment, comprises indicia different from the information being displayed by display 32 when display 32 is visible though display window 21. In a specific embodiment of the first preferred embodiment, display 32 will typically be displaying time information such as the time (e.g. “10:07”), date information (e.g. “04-22”) or compass headings (“115° SE”). However, upon the inhibiting of the view of display 32 with view inhibiting assembly 40, such time, date, compass heading or other information being displayed by display 32 is no longer viewable, and in its place is the display of other, different information, such as the day (e.g. “THU”).

In this first preferred embodiment, view-inhibiting assembly 40 comprise a day ring for displaying day information, and reference is particularly made to FIGS. 2 and 4, wherein assembly/ring 40 is preferably sectioned off into eleven (11) regions, seven (7) of which are respectively labeled with the days of the week and four (4) of which are preferably transparent (see regions 40a, 40b, 40 for example). It should also be understood that actual sections of the ring may be removed (e.g. a window) so as to provide the transparency. Therefore, “transparent” as provided herein may be achieved (and is intended to cover embodiments that include both) by the use of clear plastic or actually removed sections in the plastic (e.g. region 40d). The labeling of the regions (e.g. SUN-MON-<clear>-TUE-<clear>-WED-THU-<clear>-FRI-SAT-<clear>) is preferably configured to optimally balance a minimized number of regions with the amount of rotation ring 40 has to endure to go from a selected day to a clear/transparent region (i.e. which would permit visibility of display 32). That is, another configuration can be achieved by alternating days and clear portions (e.g. SUN-<clear>-MON-<clear>-TUE-<clear>-WED-<clear>-THU-<clear>-FRI-<clear>-SAT-<clear>) although it can be seen that this latter configuration would undesirably require smaller print (or a larger ring) with no appreciable advantage since the first mentioned configuration also permits ring 40 from being no more than one position from a clear region. In any event, the grouping of days (i.e. in the first mentioned configuration) is not critical to the invention (i.e. any one day may be isolated as exemplary done with “TUE” in the above description and in the Figures).

In the preferred embodiment, the rotation of ring 40 (which is likewise positioned on the actuation side of dial 20 (i.e. below the display window 21) is accomplished by inhibiting means in the form of a gearing assembly, comprising one or more wheels operatively coupled to a motor, preferably a stepper motor, generally indicated at 50. Stepping motor 50, which is preferably a bi-directional motor, will comprise a rotor 52 that is rotateably coupled to the at least one or more wheels of the gearing assembly. That is, rotor 52 will preferably comprise teeth that meshingly align with the outer teeth of a first wheel 55. In turn, first wheel 55 includes a pinion 57 which itself has teeth that meshingly align with teeth on the outer circumference of a second wheel 60. In a similar manner, second wheel 60 comprises a pinion 63 which itself has teeth that meshingly align with teeth on the outer circumference of a third wheel 65. This third wheel 65 likewise comprises a pinion 67 which itself has teeth that meshingly align with teeth on the outer circumference of ring 40. In this way, the rotation of rotor 52 of motor 50 causes the rotation of ring 40, as will be further explained below. Of course, it should be understood that the number of wheels (and alignment (e.g. pinion 67 of wheel 65 could engage teeth on the inner circumference of ring 40)) included in the gearing assembly may be more or less (or different as the case may be) than that disclosed herein, and are really one of design choice for the intended function and based upon a number of known criterions, such as power and torque constraints. The selection of a suitable stepping motor and the arrangement and/or positioning of the components are all within the purview of one skilled in the art.

Thus, it can now be seen that if electronic device 10 can maintain information regarding the clockwise or counterclockwise direction (and amount of rotation) of ring 40, electronic device 10 can accurately cause the rotor of stepping motor 50 to rotate in one of a forward or reverse direction (as the case may be) so that ring 40 can be properly and sufficiently rotated in the proper clockwise or counterclockwise direction. To assist in providing this functionality, a microcontroller 70 is provided.

For example, utilizing the features and embodiments disclosed and claimed in copending application Ser. No. 10/716,011, the entire disclosure of which is incorporated by reference as if fully set forth herein, microcontroller 70 will receive signals upon at least certain rotational increments of a detection wheel assembly (not shown), process such signals and based thereon, cause the rotor of stepping motor 50 to rotate in the proper clockwise or counterclockwise direction so that date ring 40 can, as the case may be, rotate clockwise or counterclockwise. In this way, the rotation of the hour wheel (not shown but fully disclosed in the aforementioned application Ser. No. 10/716,011) through a predetermined “midnight” position results in date ring 40 rotating a predetermined number of degrees, thereby advancing either in the forward or backward direction to display a subsequent, or previous, day, as the case may be.

In addition, because ring 40 is controlled by microcontroller 70 and microcontroller maintains information regarding the position of ring 40, upon the traversing of a midnight position (either forward or backward), microcontroller 70 will cause the advancement (or reversing) of ring 40 two (2) “day positions” when the subsequent (or previous) position is a clear (i.e. transparent) position. That is for example, when it is the proper time to advance ring 40 (using the illustrated example) from Tuesday (TUE) to Wednesday (WED), ring 40 will be advanced two (2) “day positions.” In this way, the transitioning from Tuesday to Wednesday will essentially be transparent to all but only the most observant users.

Again, how microcontroller 70 “knows” and maintains information regarding time information (e.g. the direction of rotation of a certain detection wheel assembly and maintaining information regarding complete 24 hour periods in the event hands 26, 28 are disengaged) is completely and fully disclosed in the aforementioned U.S. application Ser. No. 10/716,011. In this manner, not only is there disclosed a unique display alternative, but yet also a construction and methodology for maintaining accurate day information on a ring.

Reference is now made to FIGS. 5-7, which illustrate electronic device 10 constructed in accordance with a second embodiment. In this second embodiment, the view-inhibiting assembly is generally indicated at 140 and is likewise positioned on the actuation side of dial 20. Here again, view-inhibiting assembly 140 inhibits the view of display 32 through display window 21 in dial 20. Also provided in this second embodiment is inhibiting means, operatively coupled to view-inhibiting assembly 140, for causing view-inhibiting assembly 140 to inhibit the view of display 32 through display window 21. In this alternative embodiment, display 32 may likewise be displaying date, time, alarm, thermometer and/or compass heading information in a digital format, and view inhibiting assembly 40 may comprise a static hour marker (e.g. “6”) or other demarcation, the particular one of which may be a function of the position of display window 21 (e.g. at the 6 o'clock or 3 o'clock position).

In this second embodiment, the inhibiting means preferably comprises an assembly, generally indicated at 142, that comprises a wheel 145, a cam 150 operatively coupled to wheel 145, and a rotator 155 for rotating cam 150. Assembly 142 operates in the following manner:

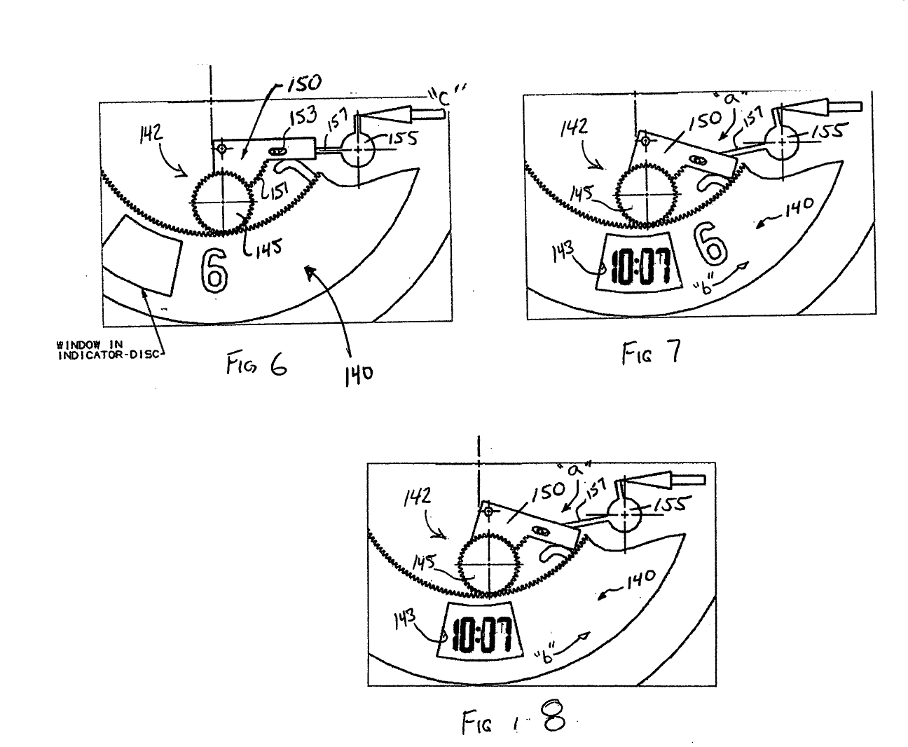

Specifically, (and in minor contrast to the first embodiment) in this second embodiment, the preferred location of the teeth on assembly 140 is on the inner circumference thereof. In this way, teeth provided on the outer periphery of wheel 145 will meshingly engage the teeth on assembly 140. Wheel 145 is preferably positioned on a pin (not shown) to provide its stationary position. On the backside of wheel 145 is preferably a pinion (not shown) which itself has teeth on its periphery. Preferably, these teeth meshingly engage teeth 151 on cam 150. In this configuration (and illustrated in FIG. 7) rotation of cam 150 in the direction of arrow “a” causes the rotation of wheel 145 in the counterclockwise direction, which in turn thus causes assembly 140 to rotate in the direction of arrow “b” thus rotating assembly 140 from a position whereby the printed numeral “6” (FIGS. 5, 6) which is otherwise appearing in display window 21 to a position whereby an open (i.e. transparent) window 143 would be aligned with display window 21 (FIGS. 1, 7).

Causing the rotation of cam 150 in the direction of arrow “a” is rotator 155 with its extended arm 157. As rotator 155 rotates in a counterclockwise direction, the distal end of arm 157 slides along a slot 153 thus urging cam 150 in its clockwise rotational direction.

As configured in FIGS. 6, 7, the normal, unbiased position of assembly 140 is that illustrated in FIG. 6. However, when an external force is exerted upon rotator 155 (i.e. which may be initiated by an external pusher (e.g. pusher P1, P2, P3 or P4)), as illustrated diagrammatically by arrow “c”, assembly 140 will rotate to the position illustrated in FIG. 7. Thus it can be seen that upon “demand” (e.g. user actuation), dial 20 can go from one whereby view-inhibiting assembly 140 inhibits the view of display 32 through display window 21 in dial 20 (FIG. 5) to one whereby display 32 is viewable (FIG. 1). In the event of a purely direct mechanical actuation (e.g. without the assistance of a controller) the biasing may be provided by a spring or other biasing arrangement.

Actuation of one of the pushers (P1, P2, P3, P4) is the preferred way to initiate the change in the dial's appearance as set forth above. Preferably, the select pusher is mechanically coupled (either directly or indirectly via a controller (e.g. controller 70) and an intermediate assembly/cam) to rotator 155 for providing the urging of rotator 155, and hence the mechanical operation as disclosed above. As one skilled in the art would appreciate, there are several methodologies for carrying out the foregoing operation. For example, a user could press a button to show display 32 and press the same pusher (or another) to view-inhibit display 32 (e.g. return assembly 40 and/or 140 to its position illustrated in FIGS. 3, 5 or 6). Likewise, assembly 40 and/or 140 could automatically return from its position in FIGS. 1 or 7 to that in FIGS. 3, 5 or 6 after some predetermined period (e.g. 2 seconds). Similarly, the return of assembly 40 and/or 140 could return to its normal position illustrated in FIGS. 3, 5 or 6 upon release of the selected pusher. Lastly, display 32 could automatically be displayed in window 21 upon the occurrence of an event (e.g. an alarm or timer expiration, just to name but two examples).

Still further, this second embodiment easily lends itself to yet another alternative embodiment wherein the view-inhibiting assembly conveys no information (i.e. is blank), as illustrated in FIG. 8. In this way, view-inhibiting assembly 140 acts to cover display 32 in display window 21 and provides dial 20 with a “cleaner” look in that the dial appears to no longer have a display window 21 (until such time as display 32 is revealed such as, for example, in the manners disclosed above). In this particular embodiment, the construction of the view-inhibiting assembly 140 illustrated in FIGS. 6 and 7 is fully applicable to this alternative embodiment shown in FIG. 8 It can thus be seen that the present invention provides numerous advantages not found in the prior art. For example, the present invention provides an improved electronic device construction that may be more aesthetically appealing to a segment of users. Furthermore, the present invention provides for increased versatility by providing a secondary display capability (e.g. day display) in the location of a first display that may be displaying different and/or unrelated information (e.g. time, date and/or compass headings).

While the invention has been particularly shown and described with respect to preferred embodiments thereof, it will be understood by those skilled in the art that changes in form and details may be made therein without departing from the scope and spirit of the invention. For example, the present invention has been disclosed by way of an electronic device, and a timepiece (e.g. a wristwatch) in the preferred embodiment. However, other electronic devices, such as heart rate monitors, compasses or other devices that have the material features set forth herein (e.g. a display 32) are contemplated and hereby covered herein. Additionally, the invention is primarily disclosed as having a single display window as set forth above. However, the present invention contemplates, and the claims cover, embodiments having more then one display window as set forth herein, with the view inhibiting assembly comprising a ring or elongated member being constructed according to the disclosure set forth herein. For example, if multiple display windows are desired, they can be provided at the 12 H and 6 H positions respectively.

What is claimed is:

1. An electronic device comprising a view-inhibitable display, the electronic device comprising:
a dial having an actuation side and a display side, wherein the dial further comprises a display window;
a display assembly, comprising a display for displaying information, positioned on the actuation side of the dial;
a view-inhibiting assembly for inhibiting the view of the display through the display window in the dial;
inhibiting means, operatively coupled to the view-inhibiting assembly, for causing the view-inhibiting assembly to inhibit the view of the display through the display window;
wherein when the view-inhibiting assembly inhibits the view of the display through the display window in the dial, there is an absence of information visible in the display window.

2. The electronic device as claimed in claim 1, wherein the inhibiting means comprises a wheel, cam and rotator assembly for initiating the inhibiting of the view of the display.

3. The electronic device as claimed in claim 1, wherein the inhibiting means comprises a pusher for initiating the inhibiting of the view of the display.

4. The electronic device as claimed in claim 1, wherein the view inhibiting assembly, positioned on the actuation side of the dial, comprises an elongated member that is movable within the area of the display window; and
wherein the elongated member comprises at least a transparent portion and an opaque portion and wherein when the transparent portion is visible in the display window the display is visible through the display window and when the opaque portion is visible in the display window the display is not visible in the display window.

5. An electronic device comprising a view-inhibitable display, the electronic device comprising:
a dial having an actuation side and a display side, wherein the dial further comprises a display window;
a display assembly, comprising a display for displaying information, positioned on the actuation side of the dial;
a view-inhibiting assembly for inhibiting the view of the display through the display window in the dial;
inhibiting means, operatively coupled to the view-inhibiting assembly, for causing the view-inhibiting assembly to inhibit the view of the display through the display window;
wherein the view-inhibiting assembly comprises indicia different from the information being displayed by the display when the display is visible through the display window.

6. The electronic device as claimed in claim 5, wherein the display displays date information in a digital format.

7. The electronic device as claimed in claim 5, wherein the display displays time information in a digital format.

8. The electronic device as claimed in claim 5, wherein the view inhibiting assembly comprises a static hour marker provided thereon.

9. The electronic device as claimed in claim 6, wherein the view inhibiting assembly comprises a static hour marker provided thereon.

10. The electronic device as claimed in claim 5, wherein the view-inhibiting assembly comprises:
a static hour marker on an opaque portion thereof; and
a transparent portion; and
wherein upon inhibiting the view of the display through the display window, the static hour marker is positioned at least essentially in the display window on the actuation side of the dial.

11. The electronic device as claimed in claim 5, wherein the view-inhibiting assembly comprises:
a time demarcation on an opaque portion thereof; and
a transparent portion; and
wherein upon inhibiting the view of the display through the display window, the demarcation is positioned at least essentially in the display window on the actuation side of the dial.

12. The electronic device as claimed in claim 11, wherein the demarcation is an hour marker indicated by a number or a “dash.”

13. An electronic device comprising a view-inhibitable display, the electronic device comprising:
a dial having an actuation side and a display side, wherein the dial further comprises a display window;
a display assembly, comprising a display for displaying information, positioned on the actuation side of the dial;
a view-inhibiting assembly for inhibiting the view of the display through the display window in the dial;
inhibiting means, operatively coupled to the view-inhibiting assembly, for causing the view-inhibiting assembly to inhibit the view of the display through the display window;
wherein the view-inhibiting assembly comprises a ring, wherein the ring is divided into regions (i) having indicia thereon and (ii) that are transparent, and wherein the inhibiting means comprises a motor operatively coupled to a gearing assembly that is itself operatively coupled to the ring;
wherein the inhibiting means rotates the ring in at least one of a counterclockwise and clockwise direction; and
wherein when the ring rotates so that the regions with indicia thereon are viewable within the display window, the display is not visible in the display window and when the ring rotates so that the transparent regions are viewable within the display window, the display is visible in the display window.

14. The electronic device as claimed in claim 13, wherein the indicia comprises day information, and wherein the transparent regions and the regions with the indicia alternate in a manner so that there are no more than two adjacent regions having indicia.

15. The electronic device as claimed in claim 14, including means for actuating rotation of the ring from one of a position wherein a region having indicia is visible in the display window to a position where a transparent region is visible in the display window.

16. The electronic device as claimed in claim 14, including a pusher, operatively coupled to the inhibiting means, for initiating the rotation of the ring from one of a position wherein a region having indicia is visible in the display window to a position where a transparent region is visible in the display window.

17. The electronic device as claimed in claim 15, wherein the ring rotates back to a position whereby a region having indicia is visible in the display window after a predetermined period of time.

18. The electronic device as claimed in claim 1, wherein the electronic device is a wristwatch.

19. The electronic device as claimed in claim 5, wherein the electronic device is a wristwatch.

20. The electronic device as claimed in claim 13, wherein the electronic device is a wristwatch.
